(19) United States
(12) Patent Application Publication
(10) Pub. No.: US 2003/0012177 A1
(43) Pub. Date: Jan. 16, 2003

(54) Efficient CDMA one-to-many service

(76) Inventor: Dan Vassilovski, Del Mar, CA (US)

Correspondence Address: Qualcomm Incorporated, Patents Department, 5775 Morehouse Drive, San Diego, CA, 92121-1714, US

(21) Appl. No.: 09/905,508

(22) Filed: Jul. 13, 2001

(51) Int. Cl. H04J 3/24; H04L 12/66

(52) U.S. Cl. 370/349; 370/352

(57) ABSTRACT

A one-to-many wireless telephone communication system includes a transmitting telephone that transmits voice packets in, e.g., CDMA to a base station in an IP-based infrastructure. The base station converts the CDMA packets to IP and sends them through the infrastructure to a communication manager, which copies the packets as many times as necessary for the recipient telephones in the group and sends the IP packets back through the infrastructure using the IP addresses of the recipients. The base stations receiving the IP packets transform them to voice packets and transmit the voice packets to the recipient telephones, thereby relieving the telephones from having to support IP.

### I. FIELD OF THE INVENTION

The present invention relates generally to enabling a one-to-many communication service using a wireless telephone.

### II. BACKGROUND OF THE INVENTION

Wireless telephones, such as but not limited to wireless telephones that communicate using Code Division Multiple Access (CDMA) spread spectrum modulation techniques, can be used to provide one-to-many communication capability (also referred to as “dispatch” or “net broadcast”). An example of such a service is the present assignee's QChat® service, disclosed in, e.g., U.S. patent application Ser. Nos. 09/518,622, filed Mar. 3, 2000, 09/518,776, filed Mar. 3, 2000, and 09/518,985, filed Mar. 3, 2000, all of which are incorporated herein by reference. Using the QChat service, a user of a CDMA telephone can press a button on the phone to automatically invoke what amounts to a private, half-duplex network to speak to one or more other CDMA telephone users on the network. By “half duplex” is meant that only one speaker at a time can talk when the button is held down. When the button is released, other speakers in the network can depress their talk buttons and speak to the other phones.

The above-mentioned service is based on transmitting voice packets that are encapsulated within standard Internet Protocol (IP)-based protocols, including UDP, IP, PPP, RTP, and RLP, which are designed to carry non-voice data (i.e., computer data) in a CDMA data service. In a data service, as opposed to a voice service, the wireless telephone essentially functions as a data conduit for a computer that is plugged into the phone. In any event, it is to be appreciated that the one-to-many communication capability of QChat is implemented using an IP-based service originally designed to carry computer data.

In the one-to-many voice service field to which the present invention is directed, a component within the CDMA infrastructure known as a communication manager arbitrates speaker and listener privileges and processes the IP packets carrying the voice data by replicating and transmitting the voice packets to the IP addresses of other wireless telephones participating in the network. While the QChat service is an effective one-to-many communication service, the present invention recognizes that it is possible to improve the latency and voice quality of the service.

Specifically, IP-related protocols increase over-the-air reliability by introducing certain communication overhead that increases latency (communication time delay), with the increased latency ordinarily not representing much if any drawback when computer data is being transmitted, but affecting the telephone's ability to transmit voice data. More specifically, since the overhead of a single IP-based data protocol unit exceeds the capacity of a single CDMA over-the-air frame, the IP-based data protocol overhead must be amortized by aggregating multiple voice frames in a single IP-based data protocol unit, resulting in added latency for voice transmission. Moreover, to maintain the added latency at a user-tolerable level, the voice packets must be reduced in size by restricting the CDMA vocoder (compression component) to encode data at rates other than its peak rate. This adversely affects voice quality.

Still further, by requiring the QChat service to use IP, increased processing requirements are imposed on the wireless telephone by requiring encapsulation of voice frames within the IP-based protocols. For instance, the wireless telephone must exercise the IP-based data protocol unit with a frequency that is dictated by the number of voice frames aggregated in the unit. With the above critical observations in mind, the present invention provides the solutions disclosed herein.

### SUMMARY OF THE INVENTION

A method for permitting one-to-many communication between a transmitting wireless telephone and at least two recipient wireless telephones includes sending voice packets unencapsulated in an IP-based protocol from the transmitting telephone to an infrastructure. The method then includes encapsulating the voice packets in an IP-based protocol at the infrastructure to render IP-based protocol packets, at least two copies of which are sent through the infrastructure. By “sending copies” is meant not only sending separate copies to individual addresses, but also sending a single copy to a multicast address that is monitored by two or more entities. Voice packets are extracted from the copies of the IP-based protocol packets and sent unencapsulated in an IP-based protocol to the recipient telephones.

In another aspect, a telephone system for use in a one-to-many communication session includes an over-the-air (OTA) transmitting endpoint indicating a group of OTA recipient endpoints and generating OTA voice packets intended for the recipients. An IP endpoint receives the OTA voice packets and outputs IP-based protocol packets in response thereto. A communication manager receives the IP-based protocol packets and duplicates them for the OTA recipient endpoints, with the IP-based protocol packets then being sent to one or more other IP endpoints. These other IP endpoints receive the IP-based protocol packets and output OTA voice packets in response thereto for transmission of the voice packets to the OTA recipient endpoints.

In yet another aspect, a one-to-many wireless telephone system includes an infrastructure component, preferably a base station, and a wireless transmitting telephone that uses a wireless telephone over-the-air (OTA) protocol such as CDMA which is not encapsulated in an Internet protocol (IP) to communicate with the infrastructure component. The infrastructure component transforms OTA information to IP information and sends the IP information through an infrastructure to a communication manager. In turn, the communication manager accesses a database of user groups to ascertain recipients in the group. As set forth below, the communication manager sends copies of the IP information to the recipient wireless telephones in the group, which includes at least three telephones including the transmitting telephone. The infrastructure component or another like infrastructure component transforms the IP information to OTA information and sends the OTA information to the recipient wireless telephones.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a presently preferred one-to-many wireless communication system; and

FIG. 2 is a flow chart of the present logic.

### DETAILED DESCRIPTION OF THE PREFERRED EMBODIMENT

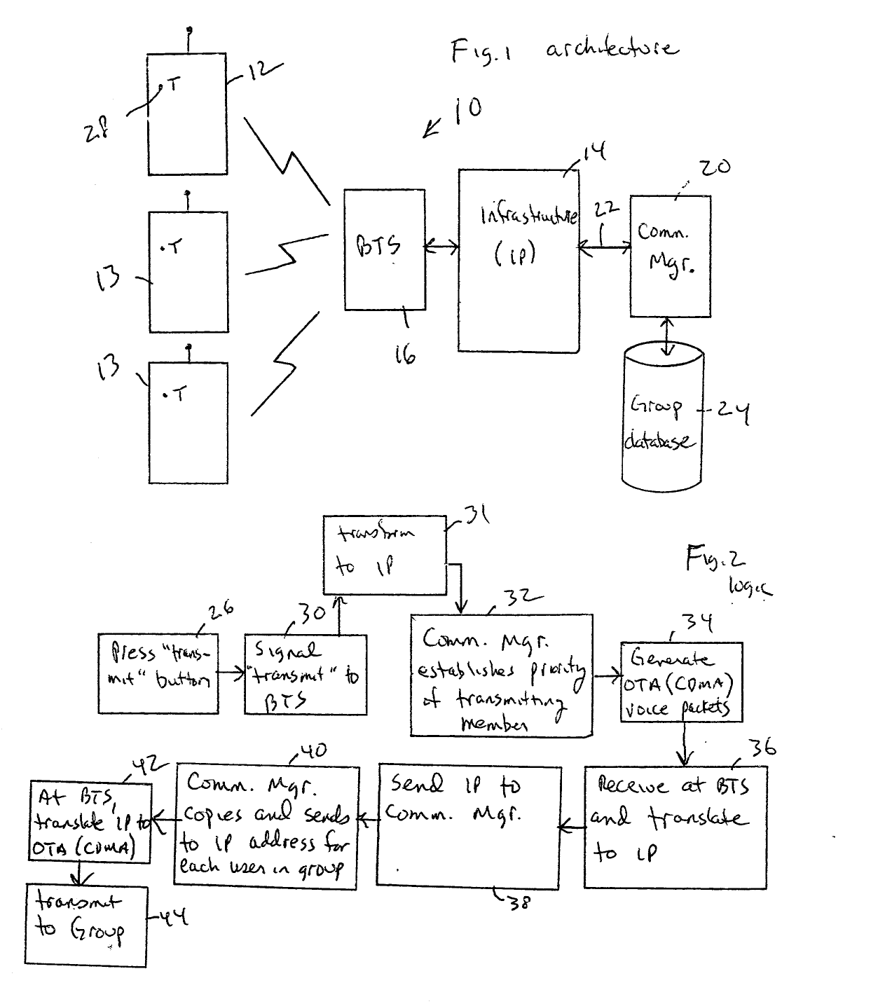

Referring initially to FIG. 1, a system is shown, generally designated 10, for effecting one-to-many communication between a transmitting wireless communication device 12 that does not support voice over Internet Protocols (VOIP) and plural group member telephones 13 that likewise do not support VOIP, via a telephony infrastructure 14 that supports IP. By “does not support VOIP” or “does not support IP” is meant that the devices 12, 13 either have no IP or VOIP capability, or that they have such capability but for improved voice performance use a standard over the air (OTA) voice protocol such as a spread spectrum scheme like CDMA or WCDMA or other wireless protocol such as but not limited to TDMA, UMTS, TD-SCDMA, etc. to communicate with the infrastructure 14. In one non-limiting embodiment the devices 12, 13 are mobile telephones made by Kyocera, Samsung, or other manufacturer that use Code Division Multiple Access (CDMA) principles and CDMA over-the-air (OTA) communication air interface protocols such as defined in but not limited to IS-95A, IS-95B, UCDMA, IS-2000, and others to communicate with the infrastructure 14.

For instance, the wireless communication systems to which the present invention can apply, in amplification to those noted above, include Personal Communications Service (PCS) and cellular systems, such as Analog Advanced Mobile Phone System (AMPS) and the following digital systems: CDMA, Time Division Multiple Access (TDMA), and hybrid systems that use both TDMA and CDMA technologies. A CDMA cellular system is described in the Telecommunications Industry Association/Electronic Industries Association (TIA/EIA) Standard IS-95. Combined AMPS and CDMA systems are described in TLA/EIA Standard IS-98. Other communications systems are described in the International Mobile Telecommunications System 2000/Universal Mobile Telecommunications Systems (IMT-2000/UM), standards covering what are referred to as wideband CDMA (WCDMA), cdma2000 (such as cdma2000 1× or 3× standards, for example) or TD-SCDMA.

The present invention applies to any wireless communication device 12; for illustration it will be assumed that the device 12 is a telephone. In general, wireless communication devices to which the present invention applies may include but are not limited to a wireless handset or telephone, a cellular phone, a data transceiver, or a paging and position determination receiver, and can be hand-held, or portable as in vehicle-mounted (including cars, trucks, boats, planes, trains), as desired. However, while wireless communication devices are generally viewed as being mobile, it is to be understood that the present invention can be applied to “fixed” units in some implementations. Also, the present invention applies to data modules or modems used to transfer voice and/or data information including digitized video information, and may communicate with other devices using wired or wireless links. Further, commands might be used to cause modems or modules to work in a predetermined coordinated or associated manner to transfer information over multiple communication channels. Wireless communication devices are also sometimes referred to as user terminals, mobile stations, mobile units, subscriber units, mobile radios or radiotelephones, wireless units, or simply as “users” and “mobiles” in some communication systems.

As shown in FIG. 1, the wireless telephone 12 communicates, using one or more of the above-mentioned systems, with at least one first infrastructure component 16 that accesses a logic module to execute the logic of the present invention. The first component 16 preferably is a base station (BTS), but it can also be implemented by base station controller (BSC), mobile switching center (MSC), gateway to a satellite system, or other infrastructure component. In any case, the first component 16 not only supports the necessary protocols and systems to communicate with the wireless device 12, but also supports IP (which includes attendant protocols or stack of IP protocols), and accordingly the component 16 communicates with the infrastructure 14.

The infrastructure 14 can include a BSC or other BTS using IP. Preferably, conventional BSC functions are undertaken by the BTS, so that no BSC need be provided. It is to be understood that while FIG. 1 shows a single BTS 16 communicating with the telephones 12, 13, each telephone 12, 13 can communicate through the infrastructure 14 via separate respective BTS.

The infrastructure component 16 thus communicates with the wireless telephones 12, 13 using OTA protocol but communicates internally to the infrastructure 14 using IP, thereby relieving the wireless telephones 12, 13 from having to support IP and attendant suite of voice over Internet protocols or from having to support any processing, use of resources, etc. related to implementing IP. Also, by using IP internally to the infrastructure 14 and OTA protocol between the telephones 12, 13 and their respective BTS 16, the advantages of using IP internal to the infrastructure 14 are realized, whereas the advantages of OTA protocol in wireless communication to the telephones 12, 13 are preserved to maximize the over-the-air capacity of the system 10. Accordingly, the infrastructure components (BTS) 16 can be thought of as virtual IP endpoints, with the actual communication endpoints being the telephones 12, 13.

As contemplated herein, the transmitting wireless telephone 12 can communicate, using the infrastructure 14, with a communication manager 20. In one non-limiting embodiment, communication between the infrastructure 14 and communication manager 20 is over a link 22 such as but not limited to the Internet. The communication manager 20 is an appropriate device that manages one-to-many communications in accordance with principles known in the art. To this end, the communication manager 20 accesses a group database 24 that contains identities and memberships of self-defined groups of telephones 12, 13. In one non-limiting embodiment, the communication manager 20 can be a QChat communication manager.

With the above overview of the present architecture in mind, it is to be understood that the present logic is executed on the architecture shown in FIG. 1 in accordance with the flow charts discussed below. The flow charts herein illustrate the structure of the logic of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer, controller, processor, etc.) to perform a sequence of function steps corresponding to those shown.

In other words, the logic may be embodied by a computer program that is executed by a processor within, e.g., the infrastructure component 16 and/or communication manager 20 as a series of computer- or control element-executable instructions. These instructions may reside, for example, in RAM or on a hard drive or optical drive, or the instructions may be stored on magnetic tape, electronic read-only memory, or other appropriate data storage device that can be dynamically changed or updated.

Now referring to FIG. 2, the logic of the present invention can be seen. Commencing at block 26, a user of the telephone 12 can press a hardware- or software-implemented “transmit” button 28 on the phone 12. The button 28 can be any suitable telephone button used for one-to-many communications, such as, by way of non-limiting example, a “send” button. It is to be understood that when the one-to-many service enables the telephone 12 to belong to multiple groups, the user can first select the desired group in accordance with one-to-many communication principles known in the art.

In any case, when the transmitting button is pressed, a “transmit” signal is sent to the component 16 at block 30. In the case wherein the telephone 12 supports IP for data services, depressing the transmit button can stimulate the telephone 12 to issue a signal to the infrastructure that the ensuing voice communications are undertaken as set forth below using OTA protocols that are not encapsulated in IP.

The transmit signal can be any appropriate signal used for signalling a one-to-many session is sought to be entered. For example, the transmit signal can be a CDMA signalling message indicating a request for one-to-many communication, and identifying the transmitting telephone 12 and the one-to-many group sought to be included, as indicated by the user by appropriately manipulating the control keys of the telephone 12.

At block 31, the transmit signal is received by the first component 16 (e.g., BTS), where in one non-limiting embodiment it is converted to IP and sent through the infrastructure 14. In one exemplary, non-limiting embodiment, the process at block 31 can include receiving a CDMA protocol one-to-many origination message from the telephone 12 in, for example, IS-95 protocol, and then in response essentially transforming the one-to-many origination message to IP by sending an IP-based Session Initiation Protocol (SIP) messages from the first component 16 to other appropriate components such as the communication manager 20 in accordance with principles known in the art.

Next, at block 32, the communication manager 20 receives the one-to-many request and establishes the priority of the transmitting telephone 12 to speak. Also, the communication manager 20 accesses the database 24 to identify the individual recipient telephones 13 in the group, as indicated by information in the signalling message. Communication channels to the group members are then established within the infrastructure 14 using the above-mentioned SIP messages, which establish communications with the intended recipient telephones 13 through their respective IP endpoints, e.g., through the first component 16 (e.g., BTS) in the simplified embodiment shown in FIG. 1 or through another BTS.

The user then speaks into the phone 12, at which time OTA voice packets such as CDMA voice packets are generated at block 34 and sent without encapsulating them in IP. At block 36, the OTA voice packets are received at the first component 16, i.e., at the IP endpoint, and translated to IP. To make this transformation, the contents of the OTA voice packets are rearranged as appropriate to conform to IP packet requirements. Typically, since OTA voice packets are smaller than IP packets and frequently are smaller than the headers of IP packets, several OTA packets might be combined into a single IP packet, although this might not necessarily be the case particularly for latency intensive applications. One of the benefits of encapsulation in IP at the infrastructure is the bandwidth use is seldom a concern, and individual voice frames may each be encapsulated in IP. Additionally, well-known IP header compression techniques can be employed to reduce the size of the headers.

The information in IP is sent through the infrastructure 14 to the communication manager 20 at block 38. Moving to block 40, the communication manager 20 copies the packets as necessary, one copy for each recipient telephone 13 in the group, and sends the duplicate IP packets to the IP address for each respective recipient telephone 13 in the group. The IP packets are then routed through the infrastructure 14 to the appropriate IP endpoints (e.g., BTS) that are in communication with the recipient telephones 13.

At the IP endpoints (e.g., BTS) for the respective recipient telephones 13, the IP packets representing the voice information from the transmitting telephone 12 are converted to OTA packets at block 42. In the simplified embodiment shown in FIG. 1, the first component 16 functions as the IP endpoint for both the transmitting telephone 12 and the recipient telephones 13. The OTA packets are sent to the recipient telephones 13 at block 44. The transformation from IP to OTA protocol is the reverse of the process for converting OTA packets to IP packets, i.e., each IP packet might be separated into a set of smaller OTA packets as appropriate to conform to the OTA protocol used by the recipient telephones 13.

The communication manager 20 also arbitrates between the telephones 12, 13 for establishing a half duplex session, i.e., a communication session wherein only a single telephone 12, 13 at a time is permitted to transmit voice packets. This arbitration can be undertaken by means known in the art. For example, when the user of the transmitting telephone 12 holds down the transmit button 28, no other telephone 13 in the group will be permitted to transmit OTA packets, until the user releases the button. Then, a user of one of the recipient telephones 13 can depress and hold their transmit button to talk in accordance with the principles set forth above.

While the particular EFFICIENT CDMA ONE-TO-MANY SERVICE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

What is claimed is:

1. A one-to-many wireless telephone system, comprising:
at least one infrastructure component;
at least one wireless transmitting telephone using a wireless telephone over-the-air (OTA) protocol not encapsulated in an Internet protocol (IP) to communicate with the infrastructure component,
the infrastructure component transforming OTA information to IP information and sending the IP information through an infrastructure to a communication manager accessing a database of user groups, the communication manager sending copies of the IP information to recipient wireless telephones in a group of at least three telephones including the transmitting telephone;
the infrastructure component or another like infrastructure component transforming the IP information to OTA information and sending the OTA information to the recipient wireless telephones.

2. The system of claim 1, wherein the OTA protocol is a code division multiple access (CDMA) air interface protocol.

3. The system of claim 1, wherein the infrastructure component is a base station (BTS).

4. The system of claim 1, wherein the infrastructure component converts OTA protocol packets to IP packets.

5. The system of claim 1, wherein the infrastructure component converts IP packets to OTA protocol packets.

6. The system of claim 4, wherein the infrastructure component converts IP packets to OTA protocol packets.

7. A method for permitting one-to-many communication between at least a transmitting wireless telephone and at least two recipient wireless telephones, comprising:
sending voice packets unencapsulated in an IP-based protocol from the transmitting telephone to an infrastructure;
encapsulating the voice packets in at least one IP-based protocol at the infrastructure to render IP-based protocol packets;
sending at least two sets of the IP-based protocol packets through the infrastructure;
extracting voice packets from the sets of the IP-based protocol packets; and
transmitting the voice packets unencapsulated in an IP-based protocol to the recipient telephones.

8. The method of claim 7, wherein the voice packets are code division multiple access (CDMA) voice packets.

9. The method of claim 7, wherein the act of encapsulating is undertaken by a base station (BTS) in the infrastructure.

10. The method of claim 7, wherein the act of extracting is undertaken by a base station (BTS) in the infrastructure.

11. The method of claim 7, comprising copying the IP-based protocol packets.

12. The method of claim 11, wherein the act of copying is undertaken by a communication manager.

13. The method of claim 7, comprising establishing half duplex communication between the telephones.

14. A telephone system for use in a one-to-many communication session, comprising:
at least one over-the-air (OTA) transmitting endpoint indicating a group of OTA recipient endpoints and generating OTA voice packets intended therefor;
at least one IP endpoint receiving the OTA voice packets and outputting IP-based protocol packets in response thereto; and
at least one communication manager receiving the IP-based protocol packets and duplicating them for the OTA recipient endpoints, the IP-based protocol packets being sent to at least one IP endpoint which receives the IP-based protocol packets and outputs OTA voice packets in response thereto for transmission thereof to the OTA recipient endpoints.

15. The system of claim 14, wherein the OTA voice packets are code division multiple access (CDMA) packets.

16. The system of claim 14, further comprising an infrastructure transmitting packets between the IP endpoint and the communication manager.

17. The system of claim 14, wherein the IP endpoint is a base station (BTS).

18. The system of claim 14, wherein half duplex communication is established by the communication manager.
